(19) United States
(12) Patent Application Publication
(10) Pub. No.: US 2018/0256452 A1
(43) Pub. Date: Sep. 13, 2018

(54) FOLDABLE BOTTLE

(71) Applicant: Yu-Hsiang CHEN, Tainan City (TW)

(72) Inventor: Yu-Hsiang CHEN, Tainan City (TW)

(21) Appl. No.: 15/808,495

(22) Filed: Nov. 9, 2017

(30) Foreign Application Priority Data
Mar. 9, 2017 (TW) 106203297

(51) Int. Cl. A61J 9/00; A61J 11/00; A61J 11/04

(52) U.S. Cl. CPC A61J 9/005; A61J 11/0035; A61J 11/04; A61J 11/008

(57) ABSTRACT

A foldable bottle includes a bottle body, which has a first annular wall extending in a top-bottom direction, a top connection wall extending upwardly from the first annular wall, a second annular wall extending downwardly from the first annular wall, a third annular wall extending downwardly and foldably from the second annular wall, and a bottom wall connected to the third annular wall. The bottle body is changeable between an unfolded state, where the second annular wall and the third annular wall are unfolded to extend outwardly and downwardly from the first annular wall, and a folded state, where the second annular wall and the third annular wall are folded and inserted into the first annular wall.

### CROSS-REFERENCE TO RELATED APPLICATION

This application claims priority of Taiwanese Patent Application No. 106203297, filed on Mar. 9, 2017.

### FIELD

The disclosure relates to a bottle, and more particularly to a foldable bottle.

### BACKGROUND

Referring to FIG. 1, a conventional baby bottle 11 and a milk powder container 12 are shown. The milk powder container 12 includes a plurality storing sections 121 stacked on each other. Each storing section 121 is able to contain a predetermined amount of milk powder used for preparing one bottle of reconstituted milk in the baby bottle 11. Because the baby bottle 11 and the milk powder container 12 as a whole can make up a relatively bulky volume, when they are needed to be carried outside, inconveniences may occur.

### SUMMARY

Therefore, an object of the disclosure is to provide a foldable bottle that can alleviate at least one of the drawbacks of the prior art.

According to the disclosure, a foldable bottle includes a bottle cover unit and a bottle body.

The bottle cover unit includes a mouth piece configured for contact with a user.

The bottle body includes a first annular wall, a top connection wall, a second annular wall, a third annular wall and a bottom wall. The first annular wall extends in a top-bottom direction of the bottle body, and has a maximum width greater than a width of the mouth piece. The top connection wall extends upwardly from the first annular wall, has an opening, and is detachably connected to the bottom cover unit. The second annular wall extends downwardly from the first annular wall, and has a top end foldably connecting the first annular wall and provided with a top width smaller than the maximum width of the first annular wall. The third annular wall extends downwardly from and is connected foldably to the second annular wall. The bottom wall is connected to the third annular wall. The bottle body is changeable between an unfolded state and a folded state. In the unfolded state, the second annular wall and the third annular wall are unfolded to extend outwardly and downwardly from the first annular wall in a consecutive manner. In the folded state, the second annular wall, and the third annular wall are folded inward and inserted into the first annular wall.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional baby bottle and a milk powder container;

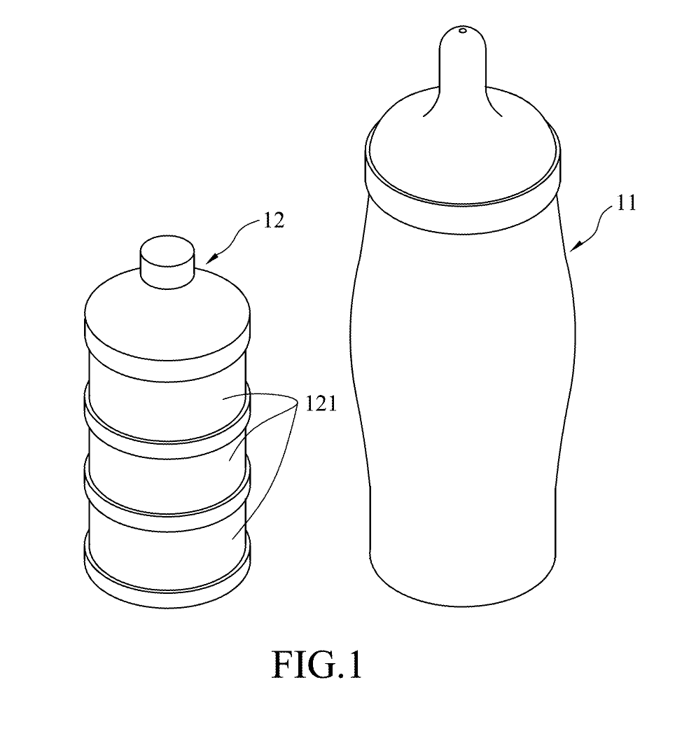

FIG. 2 is an exploded perspective view of a foldable bottle according to an embodiment of the present disclosure;

FIG. 3 is a sectional view of the embodiment, illustrating the foldable bottle in an unfolded state;

FIG. 4 is a sectional view of the embodiment, illustrating the foldable bottle in a folded state;

FIG. 5 is similar to FIG. 4, but illustrating the folded bottle storing milk powder;

FIG. 6 is a view of the embodiment, illustrating the foldable bottle in the unfolded state being held by an adult's hand;

FIG. 7 is a view of the embodiment, illustrating the foldable bottle in the unfolded state being held by baby's hands; and

FIG. 8 is a sectional view of the embodiment, illustrating a bottle body of the foldable bottle being cleaned by fingers.

### DETAILED DESCRIPTION

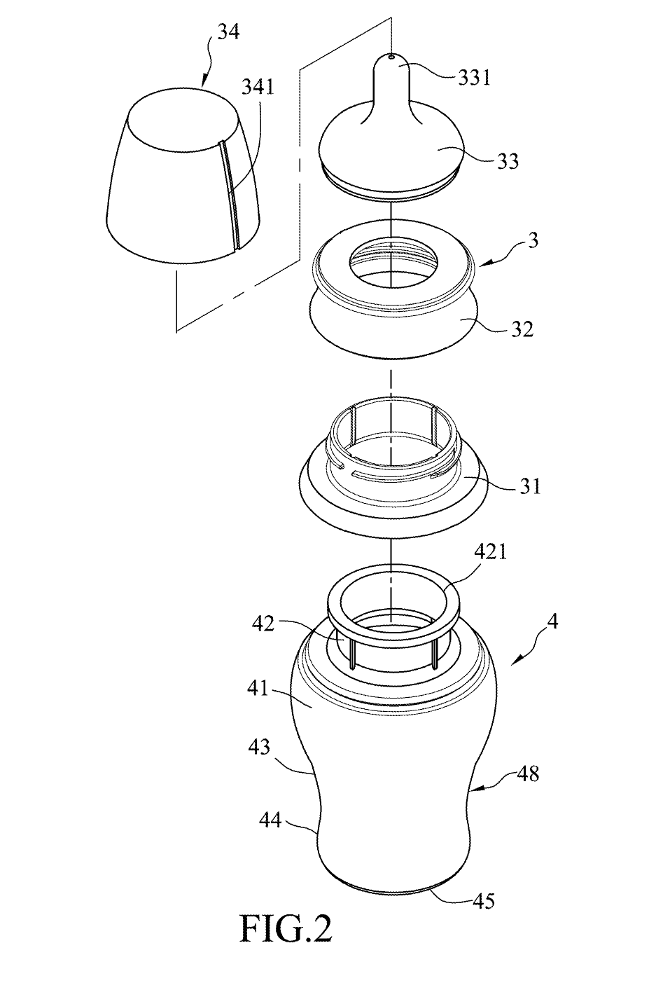

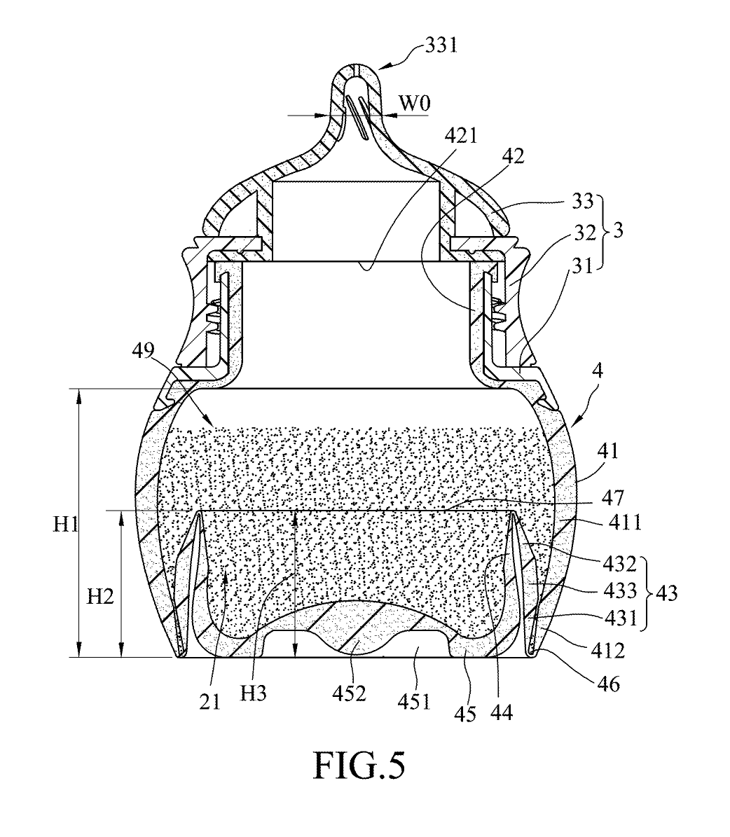

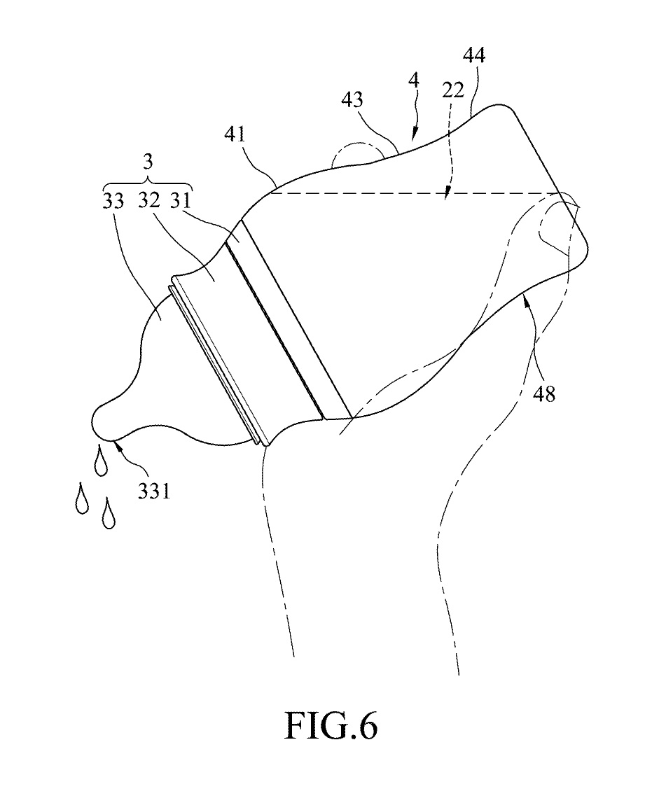

Referring to FIGS. 2 to 5, a foldable bottle according to an embodiment of the present disclosure is shown, and includes a bottle cover unit 3 and a bottle body 4. As shown in FIGS. 5 and 6, the foldable bottle is exemplified as being a baby bottle capable of storing a predetermined amount of milk powder 21 to reconstitute one bottle of liquid milk.

The bottle cover unit 3 includes a mounting seat 31 detachably connected to the bottle body 4, a connection seat 32 detachably connected to the mounting seat 31, and a functioning seat 33 detachably connected to the connection seat 32. A cap 34 is used to removably cover the bottle cover unit 3. The mounting seat 31 is narrow at its upper part and broad at its lower part and is threaded on an outer surface thereof. The connection seat 32 is a ring having an inwardly indented middle portion and a threaded inner surface for threadedly engaging the mounting seat 31. The functioning seat 33 has a mouth piece 331 in the form of a pacifier for feeding a baby the liquid milk 22 from the bottle body 4 (see FIG. 6). The mouth piece 311 has internal helical ribs disposed on an inner surface of the mouth piece 331 to ensure that the internal space of the mouth piece 311 will not be collapsed entirely and is still able to permit the liquid milk 22 to pass therethrough when the baby bites the mouth piece 331. The cap 34 has a recessed portion 341 usable to stop rolling of the cap 34. In addition, the mouth piece 331 can be in the form of a duckbill, a flat tube or a rounded tubular tube.

The bottle body 4 is made from a translucent non-toxic heat-resistant silicone material, and includes a first annular wall 41, a top connection wall 42, a second annular wall 43, a third annular wall 44 and a bottom wall 45.

The first annular wall 41 extends in a top-bottom direction of the bottle body 4, and has a middle convexity 410 that is convexed radially and outwardly. A height (H1) of the first annular wall 41, which is measured from a connection line (L1) between the first and second annular walls 41, 43, is 53.5 mm in this embodiment. The middle convexity 410 of the first annular wall 41 has a radius of curvature ranging from 35 mm to 790 mm. In addition, the first annular wall 41 has a connecting portion 411 and a first wall portion 412. The connecting portion 411 is connected to the top connection wall 42, and has a maximum width (W1) of 81.5 mm, which is greater than a width (W0) of the mouth piece 331 and which is the first largest width of the bottle body 4. The first wall portion 412 extends downwardly from the connecting portion 411, foldably connects the second annular wall 43, and has a wall thickness decreasing downwardly toward the second annular wall 43. In other embodiments, the height (H1) of the first annular wall 41 can range from 43.5 mm to 63.5 mm. The maximum width (W1) of the connecting portion 411 can range from 71.5 mm to 91.5 mm.

The top connection wall 42 extends annularly and upwardly from the first annular wall 41, has an opening 421 and a diameter smaller than an inside diameter of the first annular wall 41, and is detachably connected to the bottom cover unit 3.

The second annular wall 43 extends downwardly from the first annular wall 41. A height (H2) of the second annular wall 43, which is measured from a connection line (L2) between the second and third annular walls 43, 44, is smaller than the height (H1) of the first annular wall 41. The height (H2) of the second annular wall 43 is 25 mm in this embodiment. Further, the second annular wall 43 has a second wall portion 431 foldably connected to the first wall portion 412, a third wall portion 432 foldably connected to the third annular wall 44, and an intermediate wall portion 433 connecting the second wall portion 431 and the third wall portion 432. In other embodiments, the height (H2) of the second annular wall 43 can range from 15 mm to 35 mm, or can be smaller than or equal to one-half of the height (H1) of the first annular wall 41.

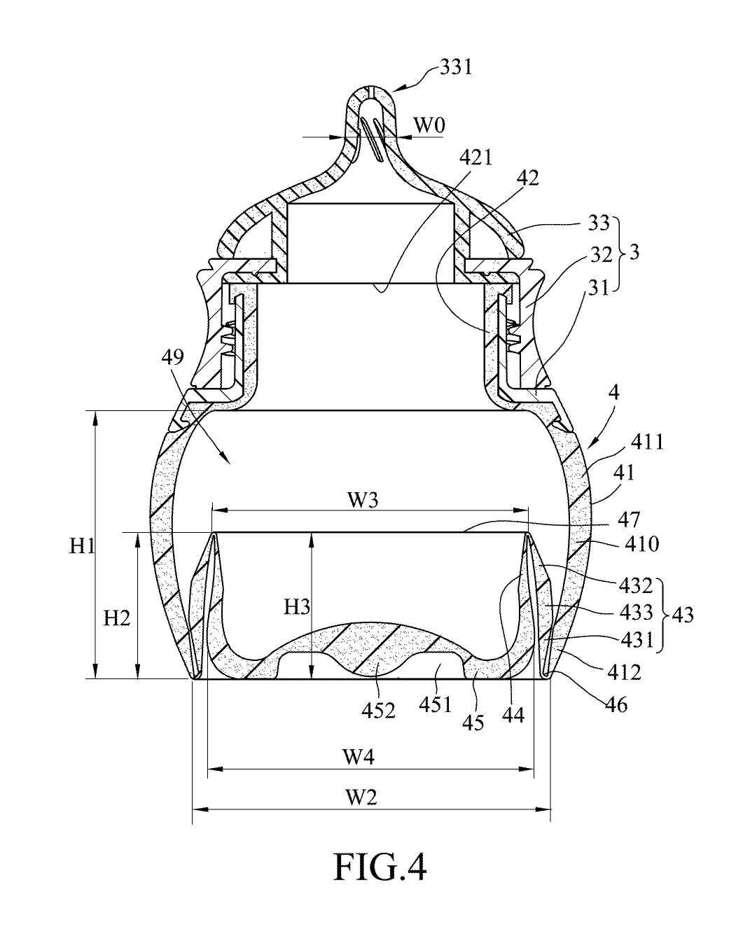

In this embodiment, the second annular wall 43 converges downwardly and arcuately from the first annular wall 41. The second wall portion 431 has a wall thickness decreasing upwardly toward the first wall portion 412. The second wall portion 431 has a top end foldably connecting the first annular wall 41 and having a top width (W2) of about 66 mm in this embodiment. The second wall portion 431 is bendable inwardly to extend into the first wall portion 412 and is foldable over an inner surface of the first wall portion 412 to form a first crease line 46 between the first and second wall portions 412, 431 (see FIG. 4). The third wall portion 432 has a wall thickness decreasing toward the third annular wall 44. A bottom end of the third wall portion 432 has a bottom width (W3) of 57.7 mm. An average thickness of the intermediate wall portion 433 is greater than that of the second wall portion 431 and that of the third wall portion 432. In other embodiments, the top width (W2) of the second wall portion 431 can range from 56 mm and 76 mm. The bottom width (W3) of the third wall portion 432 can ranges from 47.7 mm to 67.7 mm.

The third annular wall 44 extends downwardly from and is connected foldably to the second annular wall 43. Further, the third annular wall 44 diverges downwardly and arcuately from the second annular wall 43. In this embodiment, a wall thickness of the third annular wall 44 decreases toward the third wall portion 432. The third annular wall 44 has a maximum width (W4) of 60 mm in this embodiment, which is the second largest width of the bottle body 4. The maximum width (W4) of the third annular wall 44 is greater than the bottom width (W3) of the second annular wall 43, but smaller than the top width (W2) of the second annular wall 43. In other embodiments, the maximum width (W4) of the third wall 44 may range from 50 mm to 70 mm.

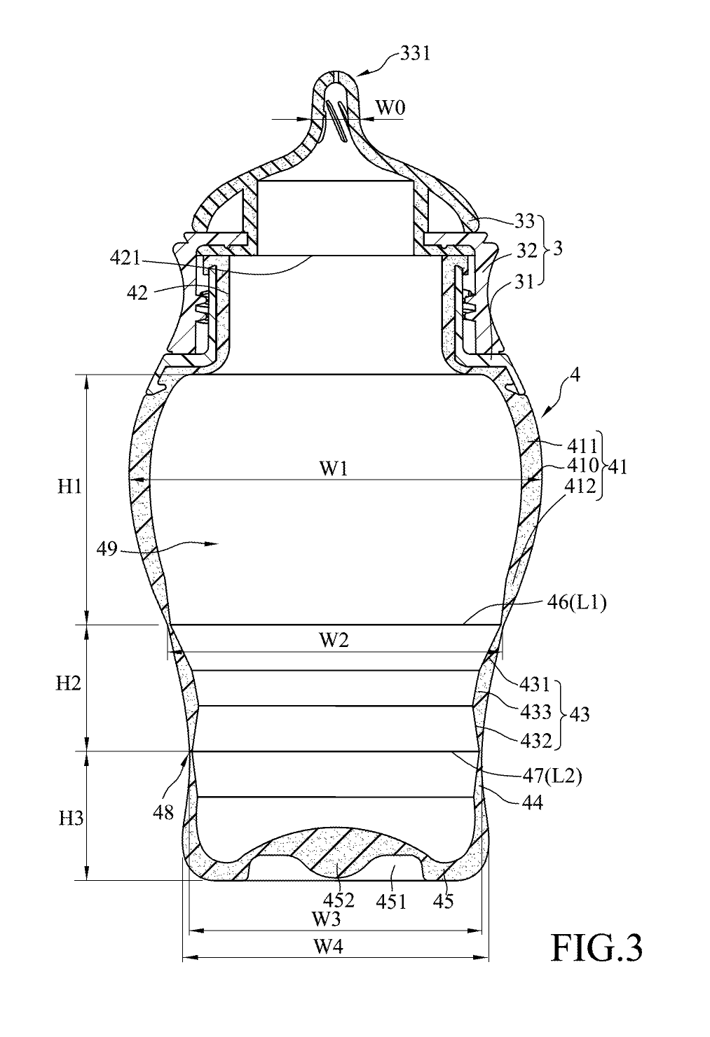

As shown in FIG. 4, when the second wall portion 431 is folded over the inner surface of the first wall portion 412, the third annular wall 44 is folded over the third wall portion 432 of the second annular wall 43 to form a second crease line 47 between the third wall portion 432 and the third annular wall 44, and the third annular wall 44 is received within the second annular wall 43. As shown in FIG. 3, in an unfolded state of the bottle body 4, outer surfaces of the first annular wall 41 and the second annular wall 43 are flush with each other at the connection line (L1) between the first and second annular walls 41, 43, and outer surfaces of the second and third annular walls 43, 44 are flush with each other at the connection line (L2) between the second and third annular walls 43, 44. In other words, in the unfolded state, the outer surfaces of the first, second and third annular walls 41, 43, 44 are neat and extend continuously to form a continuous outline that is free of irregular indents or creases. In addition, the second annular wall 43 and the third annular wall 44 cooperatively form a concavity 48 with a radius of curvature ranging from 10 mm to 350 mm.

The bottom wall 45 is connected to the third annular wall 44, and has a bottom surface formed with a recess 451 and a grasp portion 452. The recess 451 is concaved upwardly from the bottom surface. The grasp portion 452 protrudes downwardly within the recess 451 and is configured to be grasped by a user to push inward and fold the second and third annular walls 43, 44, or to pull outward and unfold the second and third annular walls 43, 44. A height (H3) of the third annular wall 44 is measured from the bottommost end of the bottom wall 45, and is smaller than the height (H1) of the first annular wall 41. The height (H3) of the third annular wall 44 is about 25.5 mm in this embodiment. In other embodiments, the height (H3) may range from 15.5 mm to 35.5 mm, or may be smaller than or equal to one half of the height (H1).

As shown in FIGS. 3 and 4, the bottle body 4 is changeable between the unfolded state and the folded state.

In the unfolded state, the second annular wall 43, the third annular wall 44, and the bottom wall 45 are extended outwardly and downwardly from the first annular wall 41 in a consecutive manner, so that the bottle body 4 has an accommodating space 49. In the folded state, the second annular wall 43 is folded over the first annular wall 41 along the first crease line 46, and the third annular wall 44 is folded over the second annular wall 43 along the second crease line 47, such that the second crease line 47 is located above the first crease line 46. Because the maximum width (W4) of the third annular wall 44 is smaller than the top width (W2) of the second annular wall 43, and the height (H2) of the second annular wall 43 and the height (H3) of the third annular wall 44 are smaller than the height (H1) of the first annular wall 41, in the folded state, the third annular wall 44, and the bottom wall 45 can be folded inward and inserted into the first annular wall 41, and the volume of the accommodating space 49 can be reduced approximately by half.

As shown in FIG. 5, in the folded state, because the height (H2) of the second annular wall 43 and the height (H3) of the third annular wall 44 are smaller than the height (H1) of the first annular wall 41, the accommodating space 49 is not overly occupied by the second annular wall 43, the third annular wall 44 and the bottom wall 45, and is sufficient to store the milk powder 21.

When the milk powder 21 stored in the accommodating space 49 is needed to be reconstituted into liquid milk 22, the user may grasp and pull outward the grasp portion 452 to extend the second annular wall 43, the third annular wall 44 and the bottom wall 45 outwardly from the first annular wall 41, thereby changing the bottle body 4 from the folded state to the unfolded state. In the unfolded state, the volume of the accommodating space 49 is enlarged so that the milk powder 21 may be reconstituted in the accommodating space 49. Alternatively, to change the bottle body 4 to the unfolded state from the folded state, the middle convexity 410 of the first annular wall 41 may be directly squeezed to force the second annular wall 43, the third annular wall 44 and the bottom wall 45 to move outwardly from the first annular wall 41 by air pressure inside the bottle body 4.

Referring to FIG. 6, when the user feeds his/her baby, the user may hold the bottle body 4 with his/her palm in abutment with the first annular wall 41 and tiger's mouth in abutment with the concavity 48.

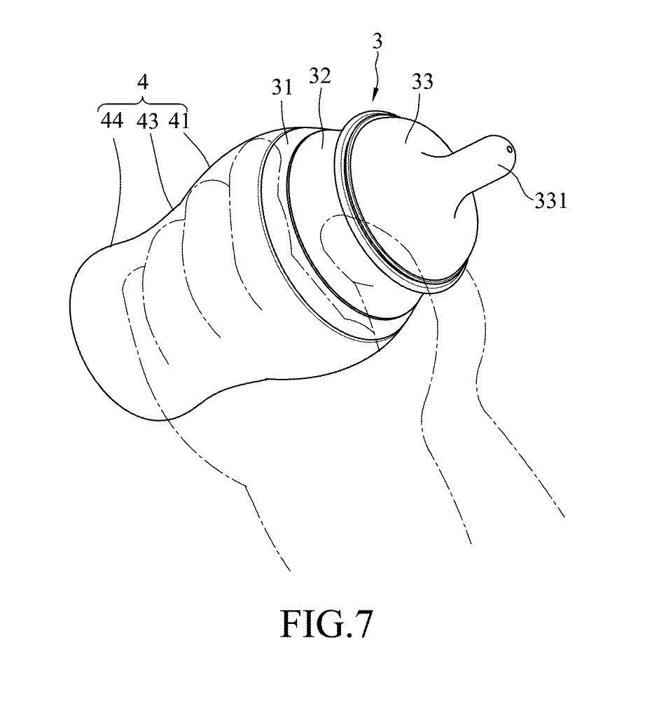

Referring to FIG. 7, the bottle body 4 permits the baby to hold the middle convexity 410 of the first annular wall 41 with two hands thereof. Because the larger width of the first annular wall 41 comes first before the smaller width of the second annular wall 43, the bottle body 4 may be held stably, and accidental release of the bottle body 4 may be avoided. Because the maximum width (W4) of the third annular wall 44 is greater than the bottom width (W3) of the second annular wall 43, the bottle body 4 can stand itself stably, and the volume thereof can be increased.

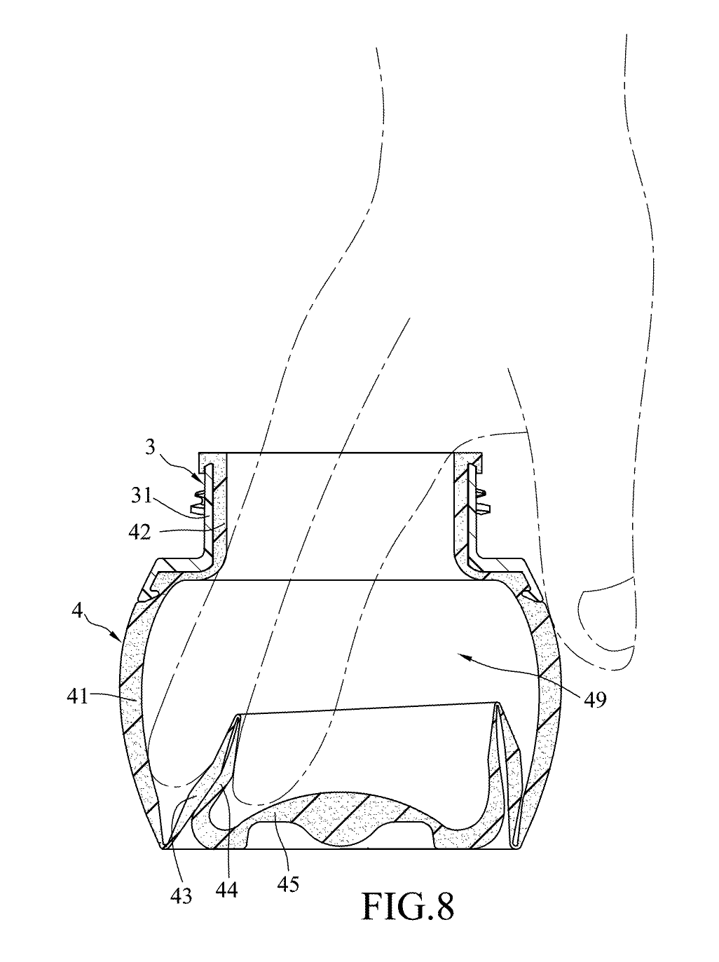

Referring to FIG. 8, the particularly designed heights and widths of the first annular wall 41, the second annular wall 43 and the third annular wall 44 permits the user to directly and conveniently clean the bottle body 4 in the folded state by extending his/her fingers into the first annular wall 41 and the second annular wall 43 and to the bottom wall 45 without using any brush or other tools. Cleaning is convenient, and there is no dead space for cleaning. Alternatively, a brush may be used for cleaning the inside of the bottle body 4 by pulling outward the bottom wall 45, and the second and third annular walls 43, 44 through a pulling action of the grasp portion 452. In addition, the bottle body 4 is flexible and squeezable since it is made from the silicone material. By putting detergent liquid or a sponge into the bottle body 4, the bottle body 4 may be rubbed and squeezed by using two hands for cleaning the inside thereof. After cleaning the bottle body 4, the grasp portion 452 may be grasped to insert the second annular wall 43, the third annular wall 44 and the bottom wall 45 into the first annular wall 41. The grasp portion 452 is advantageous to change the bottle body 4 between the unfolded and folded states.

In the unfolded state, the bottle body 4 presents a pleasant appearance because the outer surfaces of the first annular wall 41, the second annular wall 43 and the third annular wall 44 cooperatively form a neat continuous outline.

The mounting seat 31 and the connection seat 32 may be provided with different colors and shapes to vary the outer appearance of their combination. Because the mounting seat 31 and the connection seat 32 are detachable, they may be replaced individually. Since they need not be replaced entirely, they are environmentally friendly. In addition, they are beneficial for cleaning separately to ensure good hygiene and safety. The functioning seat 33 is also replaceable, so that the mouth piece 331 of the function seat 33 in the form of the pacifier may be replaced by a rounded tubular tube and the baby bottle in this embodiment is converted into a water bottle. Because the width (W0) of the mouth piece 331 is smaller than the maximum width (W1) of the first annular wall 41, it is convenient for a user to drink through the mouth piece 331.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A foldable bottle, comprising:
a bottle cover unit including a mouth piece configured for contact with a user; and
a bottle body including
a first annular wall that extends in a top-bottom direction of said bottle body, and that has a maximum width greater than a width of said mouth piece,
a top connection wall that extends upwardly from said first annular wall, that has an opening, and that is detachably connected to said bottom cover unit,
a second annular wall that extends downwardly from said first annular wall, and that has a top end foldably connecting said first annular wall and provided with a top width smaller than said maximum width of said first annular wall,
a third annular wall extending downwardly from and connected foldably to said second annular wall, and
a bottom wall connected to said third annular wall;
wherein said bottle body is changeable between an unfolded state and a folded state,
wherein in the unfolded state, said second annular wall, and said third annular wall are unfolded to extend outwardly and downwardly from said first annular wall in a consecutive manner,
wherein in the folded state, said second annular wall and said third annular wall are folded inward and inserted into said first annular wall.

2. The foldable bottle as claimed in claim 1, wherein:
said first annular wall has a middle convexity that is convexed radially and outwardly;
said second annular wall converges downwardly and arcuately from said first annular wall; and
said third annular wall diverges downwardly and arcuately from said second annular wall.

3. The foldable bottle as claimed in claim 1, wherein said third annular wall has a maximum width greater than a bottom width of a bottom end of said second annular wall.

4. The foldable bottle as claimed in claim 1, wherein:
said first annular wall has a first wall portion that is foldably connected to said second annular wall and that has a wall thickness decreasing downwardly toward said second annular wall;
said second annular wall has a second wall portion that is foldably connected to said first wall portion and that has a wall thickness decreasing upwardly toward said first wall portion, and a third wall portion that is foldably connected to said third annular wall and that has a wall thickness decreasing toward said third annular wall;
said third annular wall has a wall thickness that decreases toward said third wall portion;
said second wall portion is bendable inwardly to extend into said first wall portion and is foldable over an inner surface of said first wall portion to forma first crease line between said first and second wall portions; and
when said second wall portion is folded over said first wall portion, said third annular wall is folded over said third wall portion of said second annular wall to form a second crease line between said third wall portion and said third annular wall, and said third annular wall is received within said second annular wall.

5. The foldable bottle as claimed in claim 4, wherein said second annular wall has a height which is measured from a connection line between said second and third annular walls is smaller than or equal to a height of said first annular wall which is measured from a connection line between said first and second annular walls, a height of said third annular wall, which is measured from said bottom wall, is smaller than said height of said first annular wall.

6. The foldable bottle as claimed in claim 3, wherein, in the unfolded state, outer surfaces of said first annular wall and said second annular wall are flush with each other at a connection line between said first and second annular walls, and outer surfaces of said second and third annular walls are flush with each other at a connection line between said second and third annular walls.

7. The foldable bottle as claimed in claim 2, wherein said middle convexity of said first annular wall has a radius of curvature ranging from 35 mm to 790 mm, and said second annular wall and said third annular wall cooperatively form a concavity with a radius of curvature ranging from 10 mm to 350 mm.

8. The foldable bottle as claimed in claim 5, wherein:
the height of said first annular wall ranges from 43.5 mm to 63.5 mm;
the height of said second annular wall ranges from 15 mm to 35 mm; and
the height of said third annular wall ranges from 15.5 mm to 35.5 mm.

9. The foldable bottle as claimed in claim 3, wherein said bottom wall has a grasp portion protruding downwardly from a bottom surface of said bottom wall and configured to be grasped by a user to push inward and fold said second and third annular walls, or to pull outward and unfold said second and third annular walls.

10. The foldable bottle as claimed in claim 3, wherein said bottle cover unit further includes
a mounting seat detachably connected to said bottle body,
a connection seat detachably connected to said mounting seat, and
a functioning seat detachably connected to said connection seat and having said mouth piece.

11. The foldable bottle as claimed in claim 10, wherein said mouth piece of said functioning seat is in the form of a pacifier, a duckbill, a flat tube or a rounded tubular tube.
